(19) United States
(12) Patent Application Publication
(10) Pub. No.: US 2005/0130620 A1
(43) Pub. Date: Jun. 16, 2005

(54) Segmented radio frequency electrode apparatus and method for uniformity control

(76) Inventor: Andreas Fischer, Castro Valley, CA (US)

Correspondence Address: BURNS DOANE SWECKER & MATHIS L L P, POST OFFICE BOX 1404, ALEXANDRIA, VA, 22313-1404, US

(21) Appl. No.: 10/735,881

(22) Filed: Dec. 16, 2003

(51) Int. Cl. H04B 1/28

(52) U.S. Cl. 455/333; 455/323

(57) ABSTRACT

A segmented radio frequency (RF) powered electrode for use in plasma processing. The electrode includes a first electrode, a second electrode surrounding the first electrode, and a dielectric material interposed between the first electrode and the second electrode. The dielectric material electrically isolates the first electrode from the second electrode. At least one dual frequency radio frequency power source outputs RF power at a first frequency and a second frequency. The first frequency and the second frequency are different such that at least one radio frequency switch routes at least the first frequency or the second frequency from the at least one dual frequency source to the first electrode, the second electrode, or the first electrode and the second electrode.

### BACKGROUND

Equipment for processing semiconductor wafers in a plasma gas environment typically couple radio frequency (RF) power from the plasma gas to the wafer to effect surface treatment of the wafer (e.g., etching, deposition, etc.). In a current reactor configuration, the RF-powered electrode receives the wafer or substrate for processing. Traditionally, the RF-powered electrode is a single slab of metal, about the same size as the wafer, which couples both, a high to low frequency power source, through the wafer in a uniform fashion. Generally, the RF-powered electrode, however, does not allow the processor control of the distribution of the RF, which is moving through the RF-powered electrode or the wafer.

Accordingly, in order to control the etch rate uniformity on the wafer, in particular, for matching the etch rate at the center of the wafer to the rate of the wafer edge, existing process parameters such as pressure, gas flow and high to low frequency power ratios are used. However, considering the wide variety of etch processes, controlling the etch rate uniformity is not always possible for each and every etching process.

As the semiconductor industry moves to smaller features on each chip and the effort to transition to 300 mm wafer size for cost savings, new challenges will arise for monitoring and controlling wafer processing parameters. In particular, it will become more difficult to maintain equal etch or deposition rates across the wafer leading to non-uniformity in, for example, etch depth or profile. Accordingly, it would be desirable to have an apparatus and method of processing semiconductor wafers in plasma gas environments having improved process uniformity across the entire surface of the wafer.

### SUMMARY

One embodiment relates to a power segmented RF powered electrode apparatus for providing uniform processing of a substrate in a plasma reaction chamber. The segmented RF powered electrode apparatus includes a first electrode; a second electrode surrounding the first electrode; a dielectric material interposed between the first electrode and the second electrode, wherein the dielectric material electrically isolates the first electrode from the second electrode; at least one dual frequency radio frequency (RF) power source adapted to output RF power at a first frequency and a second frequency, wherein the first frequency and the second frequency are different; and at least one radio frequency switch adapted to at least route the first frequency or the second frequency from the at least one dual frequency source to the first electrode, the second electrode, or the first electrode and the second electrode.

Another embodiment relates to a substrate support adapted to support a substrate in a plasma reaction chamber of the plasma processing system, the substrate support including a first electrode, a second electrode surrounding the first electrode, and a dielectric material interposed between the first electrode and the second electrode, wherein the dielectric material electrically isolates the first electrode from the second electrode; at least one dual frequency radio frequency (RF) power source; at least one dual frequency radio frequency (RF) power source adapted to output RF power at a first frequency and a second frequency, wherein the first frequency and the second frequency are different; and at least one radio frequency switch adapted to at least route the first frequency or the second frequency from the at least one dual frequency source to the first electrode, the second electrode, or the first electrode and the second electrode.

A further embodiment relates to a method for processing substrates in a plasma processing system, comprising the steps of: (a) supporting a substrate on a substrate support in a plasma reaction chamber; (b) generating plasma in the plasma reaction chamber with a segmented RF powered electrode having a first electrode, a second electrode surrounding the first electrode, and a dielectric material interposed between the first electrode and the second electrode, wherein the dielectric material electrically isolates the first electrode from the second electrode; and (c) controlling distribution of power from a dual frequency RF power source supplied to the first electrode and the second electrodes so that uniform processing is applied across a surface of the substrate to be processed, wherein distribution of the power to the first electrode and the second electrode of the substrate is performed by at least one switch adapted to at least route the first frequency or the second frequency from the at least one dual frequency source to the first electrode, the second electrode, or the first electrode and the second electrode.

### BRIEF DESCRIPTION OF THE DRAWINGS

FIG. 1 illustrates a segmented radio frequency electrode and switching array according to an embodiment.

FIG. 2 illustrates a segmented radio frequency electrode and switching array according to an alternative embodiment.

FIG. 3 illustrates a segmented radio frequency electrode and switching array according to a further embodiment.

### DETAILED DESCRIPTION

In the case of a semiconductor wafer, it is typically desired to achieve uniform processing of the exposed surface of the wafer from center to edge thereof. According to one embodiment, control of the plasma density is achieved with a segmented RF-powered electrode which balances RF power such that plasma coupled to the wafer in zones adjacent to the exposed surface of the wafer provides uniform wafer processing, e.g., during etching a layer on the wafer or building up a layer on the wafer.

The segmented RF powered electrode can be incorporated in a mechanical or electrostatic chucking arrangement for holding a substrate such as a semiconductor wafer during processing thereof. The electrostatic chuck can comprise a bipolar chuck or other type of electrode arrangement. If desired, the segmented RF powered electrode can also be incorporated in an upper electrode of a parallel plate electrode arrangement of a plasma reaction chamber or in other systems such as an inductively coupled, and a helicon plasma system.

In the case of processing a wafer, it is usually desired to provide a uniform plasma density above the exposed surface of the wafer to be processed. However, depending on the treatment to be performed on the wafer surface, a non-uniform plasma density can occur above the wafer surface. For instance, the plasma density may be greater at the wafer center than at the edge thereof or vice versa. The segmented RF powered electrode according to one embodiment can provide local plasma density control and thus achieve substantial improvement in uniformity compared to previously known electrode arrangements.

A segmented RF powered electrode having a dual frequency power source can be used to improve etch rates uniformity in plasma etch processing. In the case where the segmented electrode is incorporated in the substrate support that receives a wafer for processing, the electrode can include at least a first electrode (e.g., circular electrode) and a second electrode (e.g., ring-shaped electrode). A dielectric material (e.g., ring) is interposed between the first and the second electrodes to electrically isolate the first electrode from the second electrode. Preferably the dielectric material provides sufficient insulation to substantially reduce RF cross talk between the first and second electrodes.

A dual frequency RF power source (e.g., a power source having RF generators outputting 27 MHz and 2 MHz RF power) can be connected to the first and second electrodes via at least one RF switch. The RF switch can route the RF-power to either or both of the electrodes using the at least one switch. For example, power can be routed to the first electrode, to the second electrode, or to both the first and second electrodes. If desired, a pair of dual RF power sources can be used to route power to the first electrode and the second electrode in equal or unequal amounts.

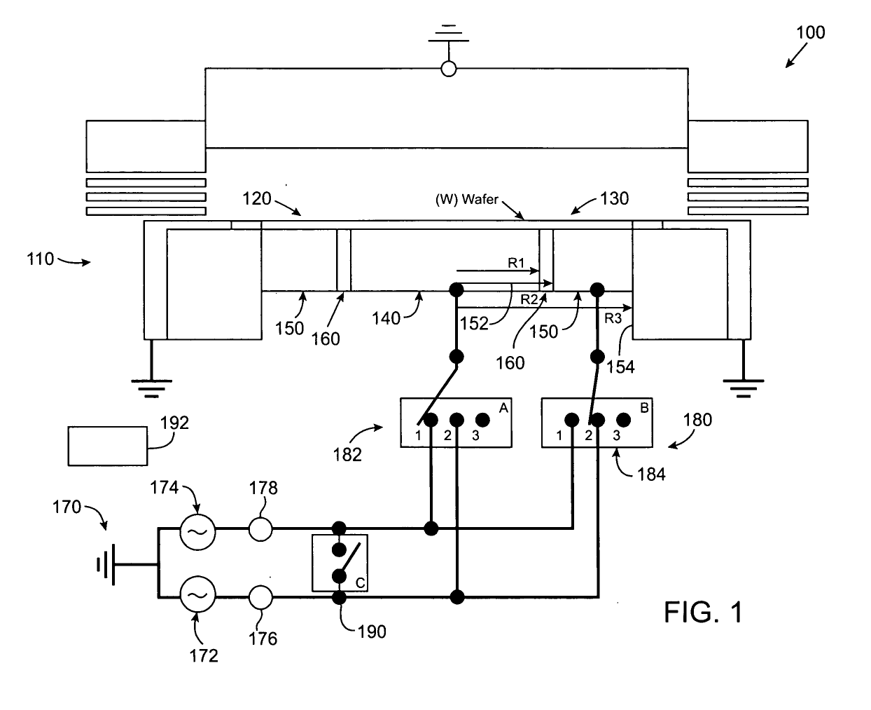

In the arrangement shown in FIG. 1, a substrate or wafer in the form of a semiconductor wafer W is supported on a substrate support 120 in the form of a wafer chuck system 110 located in a plasma reaction chamber of a plasma reactor 100. The chuck system 110 includes a segmented RF powered electrode 130 which can be used to locally vary the amount of coupling of RF energy into the plasma and, thereby, plasma to the wafer. The segmented RF powered electrode 130 includes a first electrode 140 and a second electrode 150 surrounding the first electrode 140. A dielectric material 160 is interposed between the first electrode 140 and the second electrode 150. The dielectric material 160 provides electrical isolation between the first electrode 140 and the second electrode 150.

The first electrode 140 is preferably circular and extends to a first radius (R1) 142. The first radius (R1) 142 is preferably about ⅛ to ⅞ of the total radius (or a third radius (R3) 154) of the RF powered electrode 130. For example, the first radius (R1) 142 of a segmented RF powered electrode for a 300 mm wafer can be about 18.75 mm (1.875 cm) to about 131.25 mm (13.125 cm), and more preferably about 70 mm (7 cm) to about 110 mm (11 cm) and most preferably about 90 mm (9 cm).

The second electrode 140 is preferably ring shaped and extends between a second radius (R2) 152 and a third radius (R3) 154. The second radius (R2) preferably extends from about ¼ to about ¾ of the total radius. For example, for a 300 mm wafer, the second radius (R2) 152 is between about 18.75 mm (1.875 cm) to about 131.25 mm (13.125 cm), and more preferably about 70 mm (7 cm) to about 110 mm (11 cm) and most preferably about 90 mm to about 100 mm (9 cm to 10 cm). The third radius (R3) 154 extends from the center of the segmented RF powered electrode 130 to the edge of the second electrode 150.

The dielectric material 160 is interposed between the first electrode 140 and the second electrode 150 and electrically isolates the first electrode 140 from the second electrode 150. The dielectric material 160 should be of a sufficient thickness to suppress RF cross talk between the first electrode 140 and the second electrode 150. Preferably, the dielectric material 160 has a thickness of about 5 mm to about 10 mm for processing a circular 300 mm wafer. It can be appreciated that by electrically isolating the first electrode 140 from the second electrode 150, the RF powered electrode 130 can control etch rate uniformity on the wafer. The dielectric material 160 can be any suitable material such as ceramic, quartz, polymer, or Teflon.

A dual frequency RF power source 170 adapted to output RF power at a first frequency and a second frequency, wherein the first frequency is different form the second frequency, is connected to the first electrode 140 and the second electrode 150 via at least one switch 180. The RF power source has a first RF generator 172 and a second RF generator 174 to output RF power at the first frequency and the second frequency, respectively. It can be appreciated that the dual frequency RF power source can use any combination of frequencies with 2 MHz and 27 MHz frequencies being the preferred frequencies.

The at least one switch 180 is adapted to route at least the first frequency or the second frequency from the at least one dual frequency source 170 to the first electrode 140, the second electrode 150, or the first electrode 140 and the second electrode 150. The at least one switch 180 preferably includes a first switching array 182 adapted to supply the dual frequency power source to the first electrode 140, and a second switching arraying 184 adapted to supply the dual frequency power source to the second electrode 150. Each of the switching arrays 182 and 184 include at least 3 switch positions, position 1, 2, and 3, respectively for each electrode. Switch position 1 of the switching array connects the first frequency to the electrode. Switch position 2 of the switching array connects the second frequency to the electrode. While in switch position 3 of the switching array, the electrode does not receive either frequency.

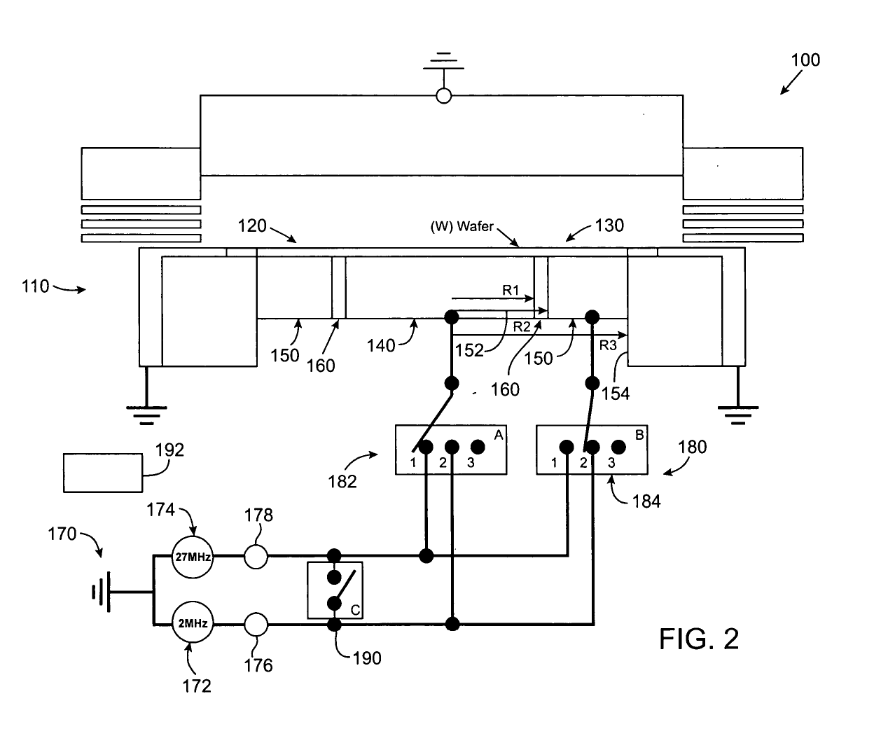

As shown in FIG. 2, the power source 170 preferably includes a 27 MHz RF generator 174 and a 2 MHz RF generator 172. Switch position 1 of each of the switching arrays 182, 184 is connected to the 27 MHz RF generator 174. Meanwhile, switch position 2 is connected to the 2 MHz RF generator 172. Switch position 3 is an open switch, wherein neither the 27 MHz nor 2 MHz RF generator is connected to either the first electrode 140 or the second electrode 150. A hi pass filter 178 and a low pass filter 176 prevent the 2 MHz and the 27 MHz frequencies from traveling in an opposite direction back into the other RF source.

Switch position 1 of the first electrode switching array 182 only allows 27 MHz RF energy to be delivered to the first electrode 130. In addition, in FIG. 2, the second electrode switching array 184 is in switch position 2 which allows only 2 MHz RF energy to be delivered to the second electrode 140. In this arrangement, the plasma generation would occur predominantly over the center regions of the wafer (i.e., first electrode or inner electrode). As a consequence, the etch rate at the center of the wafer would be higher than at the edge of the wafer.

The apparatus also includes a coupling switch 190 adapted to couple the 27 MHz and the 2 MHz RF generators to one another. If the coupling switch 190 is in an open position, the 27 MHz and the 2 MHz frequencies will not be coupled and either 27 MHz or 2 MHz frequency is delivered to the first or second electrode. Alternatively, if the 27 MHz and the 2 MHz sources are coupled, the 27 MHz and 2 MHz frequencies can be delivered to the first electrode 140, the second electrode 150, or to both the first electrode 140 and the second electrode 150 by adjusting the switch positions of the switching arrays 182, 184.

A control unit 192 preferably controls the at least one switch 180, the switching arrays 182, 184 and the control switch 190. The control unit 192 preferably includes a computer or microprocessor adapted to control distribution of RF power to the first electrode 130 and the second electrode 140. If desired, the at least one switch 180, the switching arrays 182, 184, and the control switch 190 can be operated manually.

Using the switching array of FIG. 2, each of the various switching configurations and the relative RF energy being routed to the first electrode 130 and the second electrode 140 are shown below in Table 1:

TABLE 1

| First | Second | A | B | C |
|---|---|---|---|---|
| 27 | 27 | 1 | 1 | open |
| 27 | 0 | 1 | 3 | open |
| 2 | 2 | 2 | 2 | open |
| 2 | 0 | 2 | 3 | open |
| 0 | 27 | 3 | 1 | open |
| 0 | 2 | 3 | 2 | open |
| 27 | 2 | 1 | 2 | open |
| 2 | 27 | 2 | 1 | open |
| 27 + 2 | 27 + 2 | 1, 2 | 1, 2 | closed |
| 27 + 2 | 0 | 1 | 3 | closed |
| 0 | 27 + 2 | 3 | 1 | closed |

In operation, the switching between positions is preferably controllable dynamically from a process recipe and/or in response to a sensory input for optimum uniformity control. For example, as shown in FIG. 2, if a plasma etch process starts with a known center-fast step and is followed by an edge-fast step, the process could be run in switch position 2 for the second electrode switching array 184, (and switch position 3 for the first electrode) during recipe step 1—all RF power to the second RF-driven electrode counteracting its “natural” center-fast etch rate. During recipe step 2 (edge-fast) the first electrode switching array 182 could be run in position 1 (with switch position 3 for the second electrode) to produce a higher etch rate over the first electrode.

It can also be appreciated that the controlled distribution of RF power can be used to increase and/or decrease the etch rate at the center and/or at the periphery of the wafer. For example, the etch rate at the periphery of the wafer can be increased with respect to the etch rate at the center of the wafer by routing more RF power to the second electrode than to the first electrode. The process of controlling the distribution of power to various electrodes can be performed dynamically.

In addition, via the RF switching arrays 182, 184, the segmented RF-powered electrode 130 can be used to directly and dynamically control the RF field distribution beneath the wafer and in the plasma. It can be appreciated that the recipe steps as set forth above are only examples and the amount of power to the first electrode 140 and the second electrode 150 at any moment during the etching process is limitless and should in no way be viewed as a limitation as to the recipe steps that can be used. Each of the recipes are only a few of the examples of the segmented RF-powered electrode as described herein which can be used to improve etch rate uniformity.

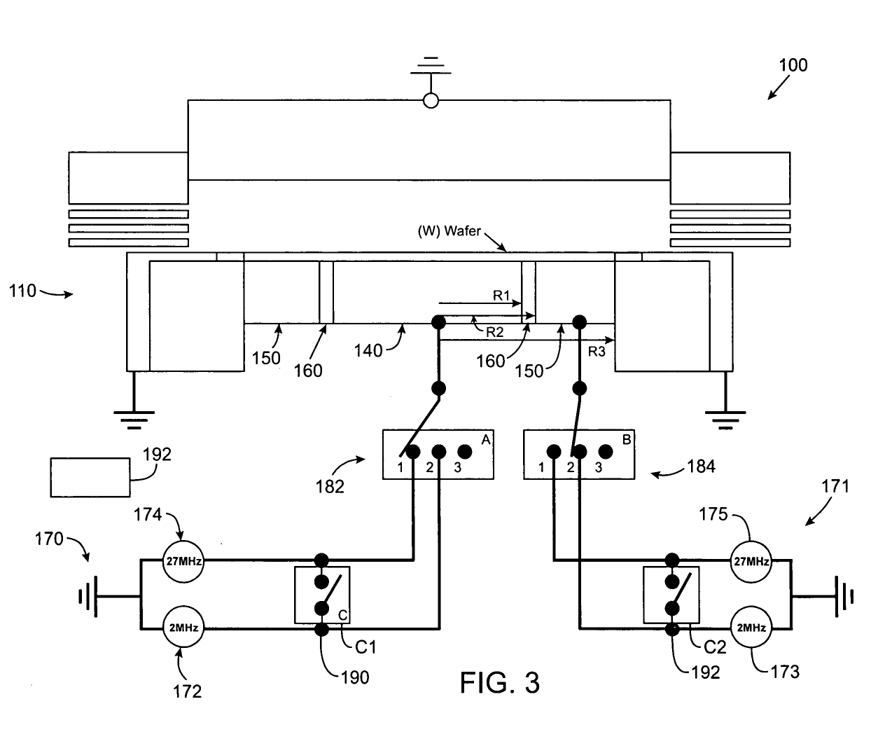

FIG. 3 is an alternative embodiment of the segmented RF-powered electrode 120 having a pair of dual frequency RF power sources 170, 171, wherein each of the RF-power sources can provide 2 MHz and 27 MHz power to the first electrode 140 and the second electrode 150 via a first switching array 182, and a second switching array 184, respectively. As shown in FIG. 3 each of the RF power sources are connected to either the first electrode 130 or the second electrode 140. Thus, the first electrode and the second electrodes can receive both 2 MHz and 27 MHz power either individually or simultaneously. Each of the switching arrays 182 and 184 include at least 3 switch positions, position 1, 2, and 3, respectively for each electrode. It can be appreciated that the pair of dual frequency RF power sources 170, 171 can use any combination of frequencies with 2 MHz and 27 MHz frequencies being the preferred frequencies.

With the arrangement of FIG. 3, each of the various switching configurations and the relative RF energy being routed to the first electrode 130 and the second electrode 140 are shown below in Table 2:

TABLE 2

| First | Second | A | B | C1 | C2 |
|---|---|---|---|---|---|
| 27 + 2 | 2 | 1, 2 | 2 | closed | open |
| 27 + 2 | 27 | 1, 2 | 1 | closed | open |
| 2 | 27 + 2 | 2 | 1, 2 | open | closed |
| 27 | 27 + 2 | 1 | 1, 2 | open | closed |
| 27 + 2 | 27 + 2 | 1, 2 | 1, 2 | closed | closed |

Although, the embodiments have been described in terms of a first electrode and a second electrode, it can be appreciated that more than two electrodes can be used for separating the electrode into zones in order to achieve the desired surface etch uniformity. Each of the electrodes is preferably electrically isolated from the adjacent electrode by a dielectric material.

In addition, it can be appreciated that, because the plasma processing is a function of chamber pressure, process gas flow rates, electrode power, temperature of the substrate or wafer, gap size between upper and lower electrodes, gas, baffle design of a shower head electrode, etch materials, RF frequencies and process windows, the electrodes in FIGS. 1-3 can be chosen to match the voltage requirements at each electrode based on known RF phase and matching requirements to tailor the fields as desired to achieve plasma processing uniformity.

The foregoing has described the principles, preferred embodiments and modes of operation of the present invention. However, the invention should not be construed as being limited to the particular embodiments discussed. Thus, the above-described embodiments should be regarded as illustrative rather than restrictive, and it should be appreciated that workers skilled in the art may make variations to those embodiments without departing from the scope of the present invention as defined by the following claims.

1. A segmented RF powered electrode apparatus for use in plasma processing, the apparatus comprising:
a first electrode;
a second electrode surrounding the first electrode;
a dielectric material interposed between the first electrode and the second electrode, wherein the dielectric material electrically isolates the first electrode from the second electrode;
at least one dual frequency radio frequency (RF) power source adapted to output RF power at a first frequency and a second frequency, wherein the first frequency and the second frequency are different; and
at least one radio frequency switch adapted to at least route the first frequency or the second frequency from the at least one dual frequency source to the first electrode, the second electrode, or the first electrode and the second electrode.

2. The apparatus of claim 1, wherein the first electrode is a circular inner electrode.

3. The apparatus of claim 1, wherein the second electrode is a ring shaped outer electrode.

4. The apparatus of claim 1, wherein the dielectric material electrically isolates the first electrode from the second electrode by suppressing radio frequency cross talk between the first electrode and the second electrode.

5. The apparatus of claim 1, wherein the at least one radio frequency switch includes a first switching array and a second switching array, the first switching array is adapted to supply the dual frequency power source to the first electrode and the second switching array is adapted to supply the dual frequency power to the second electrode.

6. The apparatus of claim 5, wherein the first switching array and the second switching array has a first switch position, a second switch position and a third switch position, the first switch position routes the first frequency to the electrode, the second switch position routes the second frequency to the electrode, and the third switch position routes neither the first frequency nor the second frequency to the electrode

7. The apparatus of claim 1, wherein the dual frequency RF power source has a 27 MHz RF generator and a 2 MHz RF generator.

8. The apparatus of claim 1, further comprising a control unit adapted to control the at least one radio frequency switch.

9. The apparatus of claim 1, further comprising a plasma etching chamber, wherein the electrode is incorporated in a substrate support, the substrate support supports a single semiconductor wafer, and the substrate support includes an electrostatic chuck which can be used in the plasma etching chamber.

10. The apparatus of claim 1, wherein the dual frequency power source comprises a single frequency power source, and a coupling switch adapted to couple the first frequency and the second frequency into the single frequency power source.

11. The apparatus of claim 1, wherein the at least one dual frequency RF power source comprises a first RF power source and a second RF power source, the first RF power source is connected to the first electrode and the second RF power source is connected to the second electrode.

12. The apparatus of claim 11, wherein the first RF power source has a first switching array adapted to connect the first RF power source to the first electrode and the second RF power source has a second switching array adapted to connect the second RF power source to the second electrode.

13. The apparatus of claim 11, wherein the apparatus further includes a coupling switch adapted to couple the first frequency and the second frequency.

14. A plasma processing system comprising:
a substrate support adapted to support a substrate in a plasma reaction chamber of the plasma processing system, the substrate support including a first electrode, a second electrode surrounding the first electrode, and a dielectric material interposed between the first electrode and the second electrode, wherein the dielectric material electrically isolates the first electrode from the second electrode;
at least one dual frequency radio frequency (RF) power source adapted to output RF power at a first frequency and a second frequency, wherein the first frequency and the second frequency are different; and
at least one radio frequency switch adapted to at least route the first frequency or the second frequency from the at least one dual frequency source to the first electrode, the second electrode, or the first electrode and the second electrode.

15. The system of claim 14, wherein the at least one radio frequency switch includes a plurality of radio frequency switching arrays, the switching arrays are adapted to supply the dual frequency RF power source to the first electrode and the second electrode.

16. The system of claim 14, wherein the dual frequency RF power source has a 27 MHz RF generator and a 2 MHz RF generator.

17. The system of claim 14, further comprising a control unit adapted to control the at least one radio frequency switch.

18. A method for processing substrates in a plasma processing system, comprising the steps of:
(a) supporting a substrate on a substrate support in a plasma reaction chamber;
(b) generating plasma in the plasma reaction chamber with a segmented radio frequency (RF) powered electrode having a first electrode, a second electrode surrounding the first electrode, and a dielectric material interposed between the first electrode and the second electrode, wherein the dielectric material electrically isolates the first electrode from the second electrode; and
(c) controlling distribution of power from a dual frequency RF power source supplied to the first electrode and the second electrodes so that uniform processing is applied across a surface of the substrate to be processed, wherein distribution of the power to the first electrode and the second electrode of the substrate is performed by at least one switch adapted to at least route the first frequency or the second frequency from the at least one dual frequency source to the first electrode, the second electrode, or the first electrode and the second electrode.

19. The method of claim 18, further comprising controlling distribution of RF power to increase the etch rate at the center of the substrate.

20. The method of claim 18, further comprising controlling distribution of RF power to increase the etch rate at the edge of the substrate.

21. The method of claim 18, wherein the step of controlling distribution of power from the dual frequency RF power is controlled by a control unit.
